(19) United States
(12) Patent Application Publication
(10) Pub. No.: US 2009/0027288 A1
(43) Pub. Date: Jan. 29, 2009

(54) ANTENNA DEVICE AND METHOD OF OPERATING THE SAME

(75) Inventors: Jong Moon LEE, Daejeon (KR); Hyuk Je KIM, Daejeon (KR); Soon Ik JEON, Daejeon (KR); Chang Joo KIM, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 12/129,801

(22) Filed: May 30, 2008

(30) Foreign Application Priority Data
Jul. 25, 2007 (KR) 10-2007-0074473

(51) Int. Cl. H01Q 3/02; H01Q 1/12

(52) U.S. Cl. 343/766; 343/879

(57) ABSTRACT

According to an antenna device of the invention, an antenna frame is formed in a tank having an opening and filled with a medium, and a plurality of antennas are mounted to the antenna frame and vertically extend such that they surround a target of diagnosis. One of the antennas includes a transmitting module that radiates microwave signals and the other antennas include receiving modules that receive the radiated microwave signals.

### CROSS-REFERENCE TO RELATED APPLICATION

This application claims priority to and the benefit of Korean Patent Application No. 10-2007-0074473 filed in the Korean Intellectual Property Office on Jul. 25, 2007, the entire contents of which are incorporated herein by reference.

### BACKGROUND OF THE INVENTION

(a) Field of the Invention The present invention relates to an antenna device and a method of operating the antenna device. More particularly, the present invention relates to an antenna device for diagnosing cancer using microwave imaging and a method of operating the antennal device.

This invention was supported by the IT R&D program of MIC [2005-F-043-01, 2007-F-043-01, Study on Diagnosis and Protection Technology based on EM].

(b) Description of the Related Art

Breast cancer has become a significant issue of concern regarding women's health with the development of the modern society. It is possible to secure a survival rate of at least 90% with early diagnosis of breast cancer. In general, X-ray mammography using an X-ray has been used as a method for a breast cancer diagnosis. However, cancer tissue of 5 mm or less is not detected by diagnosis using an X-ray, and a patient cannot undergo repeated diagnosis because of the harmful influence of the radiation.

Methods for breast cancer diagnosis using microwave imaging are being researched to overcome these problems.

Microwave imaging is a method of imaging the inside of a target using a microwave frequency. The dielectric constants of the tissues of the breast and the breast cancer are considerably different in terms of electrical characteristics at the microwave frequency, such that it is easy to isolate even a small tumor from other breast tissues. A microwave imaging apparatus is disclosed in U.S. Pat. No. 6,448,788. The microwave imaging apparatus disclosed in the above U.S. patent includes an array antenna with a plurality of antennas each having a transmitting module and a receiving module. In the operation of the array antenna, one of the antennas radiates a microwave signal for a predetermined period of time and the other antennas receive the microwave signal. Subsequently, another one of the antennas radiates a microwave signal and the other antennas receive the microwave signal. By repeating the above operation, the apparatus for microwave imaging produces an image showing the position and the size of a tumor from all of the received microwave signals after all the antennas have radiated a microwave signal once.

However, because each of the antennas performs the radiating and receiving functions in the apparatus for microwave imaging, the isolation degree between the transmitted and received signals may be deteriorated, such that an accurate diagnosis of breast cancer is difficult. Further, a switch is additionally needed between the transmitting module and the receiving module, which makes the hardware and the control program for the switch complicated.

### SUMMARY OF THE INVENTION

The present invention has been made in an effort to provide an antenna device that is capable of allowing an accurate cancer diagnosis by simplifying the hardware and increasing an isolation degree between transmitting and receiving antennas, and a method of operating the antenna device.

According to an exemplary embodiment of the present invention, an antenna device for diagnosing a target is provided. The antenna device includes a tank, an antenna frame, and an array antenna. The tank has an opening and includes a medium having a relative dielectric constant that corresponds to the tissue of the target. The antenna frame is formed in the tank. The array antenna is mounted to the antenna frame and includes a plurality of antennas that vertically extend so as to surround the target that is inserted through the opening. A first antenna of the antennas includes a transmitting module that transmits microwave signals and other second antennas include receiving modules that receive the transmitted microwave signals.

According to another exemplary embodiment of the present invention, a method of operating an antenna device including a tank filled with a medium for a diagnosis and a plurality of antennas that surround the target inserted in the tank is provided. The method includes: radiating microwave signals from a first antenna of the antennas; receiving the radiated microwave signals by other second antennas; rotating the antennas at a predetermined rotational angle of declination; and repeating the radiating, the receiving, and the rotating the same number of times as there are antennas.

According to an exemplary embodiment of the present invention, the transmitting module and the receiving modules of the array antenna are separable, such that it is possible to increase the isolation degree between the transmitting and receiving modules and achieve an accurate cancer diagnosis.

### BRIEF DESCRIPTION OF THE DRAWINGS

FIG. 1 is a front view of an antenna device according to an exemplary embodiment of the present invention;

FIG. 2 is a top plan view of an antenna device according to an exemplary embodiment of the present invention;

FIG. 3 is a perspective view showing a partial cross-section of an antenna device according to an exemplary embodiment of the present invention;

FIG. 4 is a flowchart illustrating a method of operating an antenna device according to an exemplary embodiment of the present invention;

FIG. 5 is a view illustrating the rotation of an antenna device according to an exemplary embodiment of the present invention; and

FIG. 6 is a view illustrating movement of an antenna device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, the terms “-er”, “-or”, “module”, and “block” described in the specification mean units for processing at least one function and operation, and can be implemented by hardware components or software components, and combinations thereof.

An antenna device and a method of operating the antenna device according to an exemplary embodiment of the present invention are described hereafter in detail with reference to the accompanying drawings.

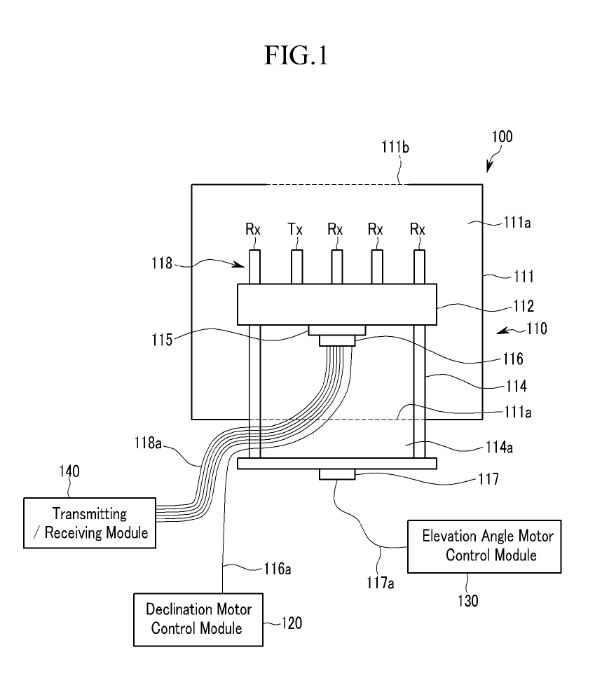

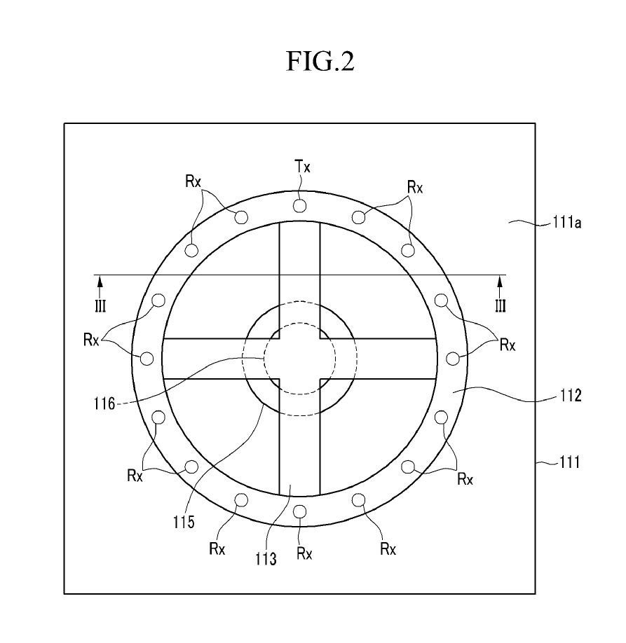

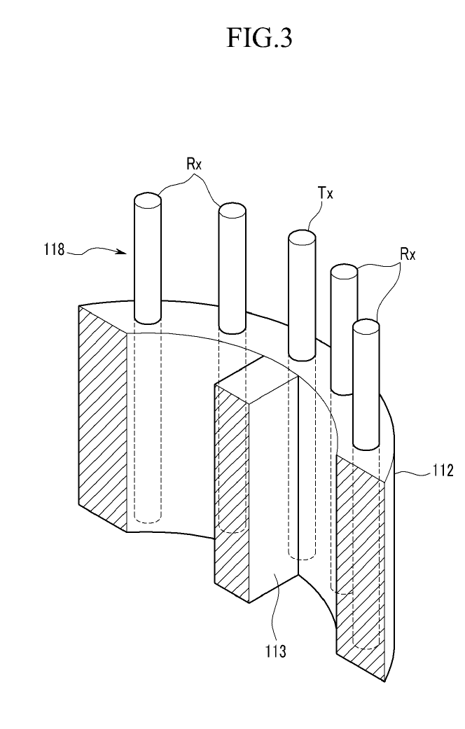

FIG. 1 is a front view of an antenna device according to an exemplary embodiment of the present invention, FIG. 2 is a top plan view of an antenna device according to an exemplary embodiment of the present invention, and FIG. 3 is a perspective view showing a partial cross-section of an antenna device according to an exemplary embodiment of the present invention.

Referring to FIG. 1 to FIG. 3, an antenna device 100 according to an exemplary embodiment of the present invention includes a tank 110, a declination motor control module 120, an elevation angle motor control module 130, and a transmitting/receiving module 140.

The tank 110 includes a main body 111, an antenna frame 112, a base frame 113, a lift case 114, a rotary joint 115, a declination motor 116, an elevation angle motor 117, and an array antenna 118.

The main body 111 has a section 111a where a media having the same relative dielectric constant as the tissue of a target of a human body for a cancer diagnosis is filled, and an opening 111b on the upper side to insert the target. The antenna frame 112 is supported by the lift case 114 in the section 111a. The antenna device 100 according to an exemplary embodiment of the present invention is applicable to a part of a human body having a relative dielectric constant that is different from that of the cancer tissue, and when the target is the breast, a liquid mixture of glycerin and water may be used as a medium.

The antenna frame 112 surrounds the target inserted through the opening 111b, and the array antenna 118 that vertically protrudes is provided in the antenna frame 112. The antenna frame 112 having a cylindrical shape is shown FIG. 1 to FIG. 3, under the assumption that the target is a breast. The base frame 113 is disposed in a straight line or a cross shape inside the antenna frame 112, and the declination motor 116 is connected with the central lower end of the base frame 113 through the rotary joint 115. The antenna frame 112 is rotated by the declination motor 116.

The declination motor 116 is connected with the declination motor control module 120 which is disposed outside the tank 110, through a cable 116a. The cable 116a may be connected with the declination motor control module 120, while passing through a through-hole (not shown) formed through the circumference of the lift case 114. The declination motor 116 rotates the antenna frame 112 at a predetermined angle in response to control of the declination motor control module 120.

The array antenna 118 includes a plurality of antennas Tx and, Rx, and the antenna Tx of the antennas Tx and Rx includes a transmitting module (not shown) that transmits a microwave signal while the other antennas Rx of the antennas Tx and Rx include a receiving module (not shown) that receives the transmitted microwave signal. An end of each cable 118a is connected with each of the antennas Tx and Rx through the antenna frame 112, and the other ends of the cables 118a are connected with the transmitting/receiving module 140 outside the tank 110 through the through-hole (not shown) formed through the circumference of the lift case 114. It is assumed hereafter that an antenna including a transmitting module is the transmitting antenna Tx and an antenna including a receiving module is the receiving antenna Rx.

The lift case 114 has a section 114a to receive the declination motor 116 and the cables 116a and 118a, and it rotates by the elevation angle motor 117 and moves upward or downward. As the lift case 114 moves down, a part of the lower portion of the lift case 114 protrudes from the main body 111 through a through-hole formed with the same size as the lift case 114 at the center portion of the bottom of the main body 111.

The elevation angle motor 117 is attached to the bottom of the lift case 114 and is connected with the elevation angle motor control module 130 outside the tank 110, through a cable 117a. The elevation angle motor 117 rotates to moves the lift case 114 up/down in response to control of the elevation angle motor control module 130.

The motor control module 120 generates control signals to rotate the antenna frame 112 at a predetermined angle of declination, and the control signals are transmitted to the declination motor 116 through the cable 116a.

The elevation angle motor control module 130 generates control signals to rotate and move the lift case 114 up/down by a predetermined distance, and the control signals are transmitted to the elevation angle motor 117 through the cable 117a.

The transmitting/receiving module 140 transmits microwave signals to the transmitting antenna Tx through the cable 118a connected with the transmitting antenna Tx, and receives microwave signals from the receiving antennas Rx through the cables 118a connected with the receiving antennas Rx. A cancer diagnosis is performed for the target using the received microwave signals.

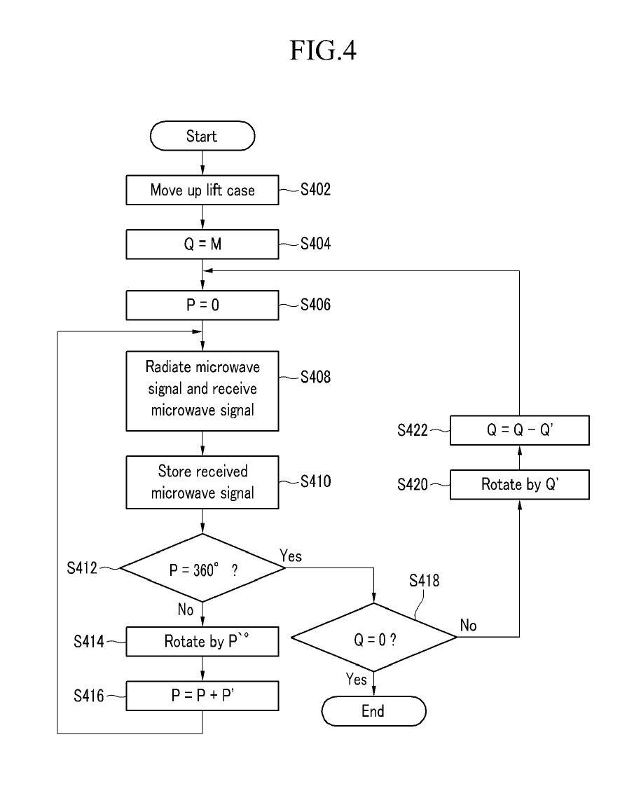

A method of operating an antenna device according to an exemplary embodiment of the present invention is described hereafter with reference to FIG. 4 to FIG. 6.

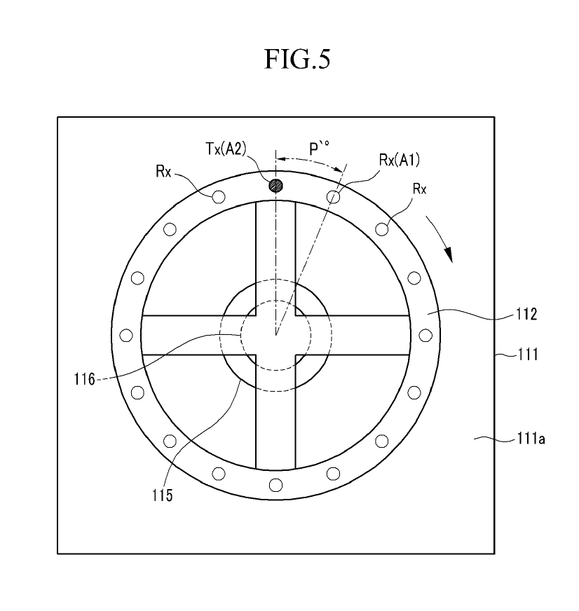

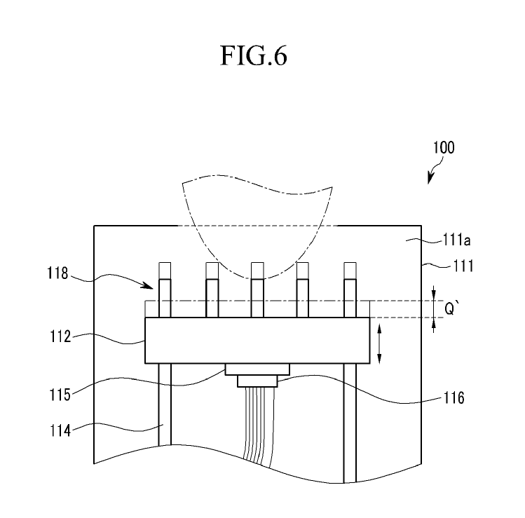

FIG. 4 is a flowchart illustrating a method of operating an antenna device according to an exemplary embodiment of the present invention, FIG. 5 is a view illustrating the rotation of an antenna device according to an exemplary embodiment of the present invention, and FIG. 6 is a view illustrating movement of an antenna device according to an exemplary embodiment of the present invention.

As shown in FIG. 4, the elevation angle motor 117 lifts the lift case 114 by control of the elevation angle motor control module 130 such that the array antenna 118 moves up to the uppermost portion of the target inserted in the tank 110 (S402). The elevation angle motor control module 130 then sets Q to M (S404). The declination motor control module 120 then sets P to 0° (S406). P represents a rotational angle of declination of a reference antenna, and the transmitting antenna (Tx) may be set to be the reference antenna. Q represents a movement distance of the lift case 114 and M represents the total movement distance of the lift case 114.

After the default values are set as described above, the transmitting antenna Tx transmits microwave signals for a predetermined time and the receiving antennas Rx receive the transmitted microwave signals for the predetermined time (S408). The transmitted microwave signals may include microwave signals that do not pass through the target, microwave signals that pass through the target, and scattered microwave signals.

The transmitting/receiving module 140 receives the microwave signals received by the receiving antennas Rx through the cables and then saves them (S410).

After determining whether P is 360° (S412), the declination motor control module 120 transmits a control signal to the declination motor 116 to activate the declination motor 116, when P is less than 360°. The declination motor 116 rotates the antenna frame 112 by P′ in response to the control signal of the motor control module 120 (S414). P′ is a predetermined rotational angle. Accordingly, as shown in FIG. 5, the antenna functioned as the transmitting antenna Tx moves to the position A1 for operating as a receiving antenna Rx, and the next antenna moves to the position A2 to function as the transmitting antenna Tx. In FIG. 5, the antenna frame rotates clockwise. Thereafter, P′ is added to P (S418) and the steps S408 to S410 are performed. Further, it is determined whether P is 360° (S412) and the steps S414, S416, and S406 to S412 are repeated until P becomes 360°.

When P is 360°, the elevation angle motor control module 130 determines whether Q is 0 (S418), and then transmits a control signal to the elevation angle motor 117 to activate the elevation angle motor 117 when Q is more than 0. As shown in FIG. 6, the elevation angle motor 117 moves the lift case 114 down by a distance Q′ in response to the control signal of the elevation angle motor control module 130 (S420). Q′ is a predetermined movement distance.

After the lift case 114 moves down by Q′, Q′ is subtracted from Q (S422). Thereafter, the steps S406 to S416 are repeated until P becomes 360°. Further, the elevation angle motor control module 130 determines whether Q is 0 (S418), and the steps S420, S422, and S406 to S418 are repeated until Q becomes 0.

Through the repetition of the steps, the transmitting antenna Tx can radiate microwave signals to the entire target and the receiving antennas Rx can receive the radiated microwave signals for the entire target. A cancer diagnosis is performed using the transmitted microwave signals. Specifically, when the target is the breast, the relative dielectric constants of the tissue of the breast and the tissue of the breast cancer are different. Since the relative dielectric constant of the breast cancer tissue is significantly larger than that of the healthy breast tissue, the breast cancer tissue scatters the microwave signal. Therefore, the magnitude and phase of the received microwave signal are different from them of the transmitted microwave signal. The receiving antennas Rx receive the scattered microwave signals and the microwave signals passing through and not passing through the breast, and the transmitting/receiving module 140 stores the signals received by the receiving antennas Rx. A 3D image that shows the size and position of the breast cancer can be produced from the signals stored in the transmitting/receiving module 140, and a cancer diagnosis is possible from the 3D image.

The embodiment of the present invention described above is not implemented by only the method and apparatus, but it may be implemented by a program for executing the functions corresponding to the configuration of the exemplary embodiment of the present invention or a recording medium having recorded thereon the program. These implementations can be realized by the ordinary skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An antenna device for diagnosing a target, comprising:
a tank having an opening and including a medium having a relative dielectric constant corresponding to tissue of the target;
an antenna frame disposed in the tank; and
an array antenna mounted to the antenna frame and including a plurality of antennas that vertically extend so as to surround the target that is inserted through the opening,
wherein a first antenna of the plurality of antennas includes a transmitting module that transmits microwave signals and other second antennas of the plurality of antennas include receiving modules that receive the transmitted microwave signals.

2. The antenna device of claim 1, further comprising:
a declination motor control module that generates a control signal to rotate the antenna frame at a predetermined rotational angle of declination; and
a declination motor that rotates the antenna frame at the rotational angle in response to control of the motor control module.

3. The antenna device of claim 2, wherein the rotational angle is determined depending on the number of the plurality of antennas.

4. The antenna device of claim 3, wherein:
the declination motor control module rotates the antenna frame after the receiving modules receive the microwave signals transmitted from the transmitting module; and
the rotation is repeated until the rotational angle of the antenna frame becomes 360°.

5. The antenna device of claim 4, further comprising:
an elevation angle motor control module generating control signals to rotate the antenna frame so as to move up/down by a predetermined movement distance; and
an elevation angle motor rotating the antennas in response to control of the elevation angle motor control module so as to move by the distance,
wherein the elevation angle motor control module generates the control signal when the rotational angle becomes 360°.

6. The antenna device of claim 5, wherein the elevation angle motor control module moves the antenna frame up/down, and the movement is repeated a predetermined number of times.

7. The antenna device of claim 1, further comprising
a transmitting/receiving module that transmits the microwave signals to the first antenna and stores the microwave signals received by the second antennas,
wherein the diagnosis is performed using the stored microwave signals.

8. The antenna device of claim 1, wherein the medium is a liquid mixture of glycerin and water.

9. The antenna device of claim 1, wherein the target of the diagnosis is breast cancer.

10. A method of operating an antenna device that includes a tank filled with a medium for diagnosis and a plurality of antennas that surround a target inserted in the tank, the method comprising:
radiating microwave signals from a first antenna of the plurality of antennas;
receiving the radiated microwave signals by other second antennas of the plurality of antennas;
rotating the antennas at a predetermined rotational angle of declination; and
repeating the radiating, the receiving, and the rotating the same number of times as there are the plurality of antennas.

11. The method of claim 10, further comprising:
after the repeating, moving the plurality of antennas by a predetermined movement distance; and
repeating the repeating and the moving a predetermined number of times.

12. The method of claim 11, wherein the rotational angle is determined depending on the number of the plurality of antennas.

13. The method of claim 10, wherein the diagnosis is performed on the basis of magnitudes and phases of the transmitted microwave signals.

14. The method of claim 10, wherein the target of the diagnosis is breast cancer.
